(19) United States
(12) Patent Application Publication
(10) Pub. No.: US 2010/0014584 A1
(43) Pub. Date: Jan. 21, 2010

(54) Methods circuits and systems for transmission and reconstruction of a video block

(76) Inventors: Meir Feder, Herzliya (IL); Guy Dorman, Holon (IL); Danny Stopler, Holon (IL); Yoad Bar-Shean, Beit-Arie (IL)

Correspondence Address: EITAN MEHULAL LAW GROUP, 10 Abba Eban Blvd. PO Box 2081, Herzlia, 46120, IL

(21) Appl. No.: 12/458,568

(22) Filed: Jul. 16, 2009

Related U.S. Application Data
(60) Provisional application No. 61/081,408, filed on Jul. 17, 2008.

(51) Int. Cl. H04N 7/12

(52) U.S. Cl. 375/240.12; 375/E07.026

(57) ABSTRACT

Disclosed is a method, circuit and system for transmission and reconstruction of a video block. A video stream may be composed of sequential video frames, and each video frame may be composed of one or more video blocks including a set of pixels. Prior to transmission of the data associated with a video block, the video block data may be transformed into a set of transform (e.g. frequency) coefficients using a spatial to frequency transform such as a two dimensional discrete cosine transform. Selection of the subset of transform coefficients to be transmitted may be based on a characteristic of the video block.

### FIELD OF THE INVENTION

The present invention relates generally to the field of communication and, more particularly, to a methods, circuits and systems for transmission and reconstruction of a video block.

### BACKGROUND

Wireless communication has rapidly evolved over the past decades. Even today, when high performance and high bandwidth wireless communication equipment is made available there is demand for even higher performance at higher data rates, which may be required for more demanding applications.

Video bearing signals may be generated by various video sources, for example, a computer, a game console, a Video Cassette Recorder (VCR), a Digital-Versatile-Disc (DVD), or any other suitable video source. In many houses, for example, video content is received through cable or satellite links at a Set-Top Box (STB) located at a fixed point.

In many cases, it may be desired to place a display, screen or projector at a location at a distance of at least a few meters from the video source. This trend is becoming more common as flat-screen displays, e.g., plasma or Liquid Crystal Display (LCD) televisions are hung on walls. Connection of such a display or projector to the video source through cables is generally undesired for aesthetic reasons and/or installation convenience. Thus, wireless transmission of the video signals from the video source to the screen may be preferable.

Often, flat screen displays are designed for viewing High-Definition-Television (HDTV) signals that may demand high data rates for transmission since the data is often uncompressed. Existing video data compression/decompression techniques may not be adequate for wireless transmission of HDTV signals at acceptable quality levels due to latency and may not be compatible with all video sources.

There is thus a need in the field of video data communication for improved methods, circuits, devices and systems for transmission.

### SUMMARY OF THE INVENTION

The present invention is a method, circuit and system for transmission and reconstruction of a video block. According to some embodiments of the present invention, a video stream may be composed of sequential video frames, and each video frame may be composed of one or more video blocks including a set of pixels. Prior to transmission of the data associated with a video block, the video block data may be transformed into a set of transform (e.g. frequency) coefficients using a spatial to frequency transform such as a two dimensional discrete cosine transform. According to some embodiments of the present invention, only a portion or subset of the coefficients of a given video block may be transmitted. Selection of the subset of transform coefficients to be transmitted may be based on a characteristic of the video block. According to further embodiments of the present invention, only that subset to be transmitted may be calculated and transmitted.

According to further embodiments of the present invention, a first portion or subset of the coefficients may be transmitted using a first RF data link and a second portion or subset of the coefficients may be transmitted using a second RF link. One of the RF link may be more reliable than the other RF link. One set of coefficients may include more spatial information than another set of coefficients.

According to further embodiments of the present invention, selection of which subset of coefficients of a given block to transmit, or of which coefficients to transmit over a more reliable RF link and which subset to transmit over a less reliable link, may be performed by a coefficient selection module and may be based on a comparison of the given video block's pixel data against corresponding pixel data of one or more corresponding video blocks from one or more previous video frames stored in a buffer. According to further embodiments of the present invention where transmission of the video block data may not be absolutely in real time, a comparison of the given video block's data may also include a comparison against corresponding blocks from subsequent video frames. The comparison of a video block's data against the data of a corresponding video block in another frame may provide an indication as to the spatial/temporal deviation of the block relative to the corresponding video block in the previous frame—indicating whether the video block is static (i.e. substantially the same as) or dynamic (i.e. different from) relative to the corresponding block in the previous frame.

According to further embodiments of the present invention, a comparison of the given block against one or more corresponding blocks may produce an indicator of the spatial/temporal difference between the compared blocks. If this indicator (e.g. deviation value) is below a given threshold, indicating the block is relatively similar to the previous block, the coefficient selector module may select a first subset of coefficients for transmission. If the indicator is above the given threshold, indicating a dynamic block, the selector module may select a second subset of coefficients for transmission, which second set may be fully or partially overlapping with the first subset. According to some embodiments of the present invention, the first subset of coefficients may include less or more spatial data than the second subset of coefficients. According to further embodiments of the present invention, for video blocks associated with indicators indicating a deviation/difference above the threshold value, the second subset of coefficients may be selected for transmission over a more reliable RF link and the first subset may be selected for transmission over a second, less reliable, RF link.

According to further embodiments of the present invention, the threshold for designating a given block static or dynamic may itself be dynamically calculated. The threshold may, for example, be set lower for the given block if one or more of the given block's neighboring blocks have been designated as static. The threshold may be set higher if one of more of the given block's neighboring blocks have been designated as being dynamic.

According to further embodiments of the present invention, the coefficient selector module may dynamically select a subset of coefficients for transmission based on the deviation values of corresponding blocks. According to some embodiments of the present invention, there may be a functionally associated algorithm or method for increasing the robustness (e.g. size) of the subset of coefficients when there is an increasing deviation between corresponding blocks (e.g. full coefficient set transmission when blocks deviate completely from associated blocks). According to further embodiments of the present invention, when there is little deviation between corresponding blocks, it may be desirable to select a previously unselected subset of coefficients from a preceding corresponding block to integrate the formerly omitted data with the corresponding block data already selected.

According to some embodiments of the present invention, when a given video block is determined to be static, the coefficient selector may select coefficients which have were not transmitted for the corresponding block in the previous frame. An indicator indicating that this block is static may be transmitted along with the selected coefficients. An image reconstruction module (e.g. decoder and graphics circuit) on the receiver side (e.g. video sink) may receive the indicator and in response may keep the previously generated video block image and may use the received coefficients to augment or enhance the previously generated video block image. The coefficient set selected for a video block designated as static may also include coefficients previously transmitted for a corresponding block from the previous frame. These retransmitted coefficients, which were transmitted as part of the previously frame, may be used by the reconstruction module enhance the displayed video image by averaging corresponding coefficient values, thereby reducing possible image generating errors due to fidelity lose during transmission/reception. Coefficients selected for a video block designated as static and used by the reconstruction module to enhance a previously generated video image may be termed “complimenting coefficients”.

According to further embodiments of the present invention, there may be proportionality between the subset of coefficients selected and the reliability of the transmission. According to some embodiments of the present invention, the reliability may be based on the security of the transmission link and/or the type of transmitter used from a plurality of available transmitters. According to some embodiments of the present invention, an RF link with low reliability may transmit block transform coefficient data along unreliable bit streams which may not include data link protocols including data frames or flow/error control. According to further embodiments of the present invention, a reliable RF link may include data link protocols including the framing of coefficient data and flow/error control. According to some embodiments of the present invention, acknowledgments, negative acknowledgements, error detection and/or correction, and checksums may be implemented as features of a reliable RF link.

The present application claims priority from U.S. Provisional Patent Application No.: 61/081,408, filed on Jul. 17, 2008. The '408 Application is hereby incorporated by reference in its entirety.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. Moreover, some of the blocks depicted in the drawings may be combined into a single function. The figures are listed below.

FIG. 1 is a functional block diagram of an exemplary video data transmitter/receiver pair according to some embodiments of the present invention where the transmitter includes a transform coefficient generator selector and packetizer block;

FIG. 2 is a functional block diagram of a transform coefficient selector and packetizer according to some embodiments of the present invention;

FIG. 3 is a flow chart including the steps of an exemplary method by which video data frame blocks may be assigned transform coefficients for transmission of video data.

FIG. 4 is a schematic illustration of a wireless video communication system, in accordance with some demonstrative embodiments;

FIG. 5 is a schematic illustration of a block classifier, in accordance with some demonstrative embodiments; and

FIG. 6 is a schematic flow-chart illustration of a method of wireless video communication, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that some embodiments may be used in a variety of applications. Although embodiments of the invention are not limited in this respect, one or more of the methods, devices and/or systems disclosed herein may be used in many applications, e.g., civil applications, military applications, medical applications, commercial applications, or any other suitable application. In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (A/V) receivers/transmitters, gaming consoles, video cameras, video recorders, portable media players, cell phones, mobile devices, and/or automobile A/V accessories. In some demonstrative embodiments the methods, devices and/or systems disclosed herein may be used in the field of Personal Computers (PC), for example, as part of any suitable desktop PC, notebook PC, monitor, and/or PC accessories. In some demonstrative embodiments the methods, devices and/or systems disclosed herein may be used in the field of professional A/V, for example, as part of any suitable camera, video camera, and/or A/V accessories. In some demonstrative embodiments the methods, devices and/or systems disclosed herein may be used in the medical field, for example, as part of any suitable endoscopy device and/or system, medical video monitor, and/or medical accessories. In some demonstrative embodiments the methods, devices and/or systems disclosed herein may be used in the field of security and/or surveillance, for example, as part of any suitable security camera, and/or surveillance equipment. In some demonstrative embodiments the methods, devices and/or systems disclosed herein may be used in the fields of military, defense, digital signage, commercial displays, retail accessories, and/or any other suitable field or application.

Although embodiments of the invention are not limited in this respect, one or more of the methods, devices and/or systems disclosed herein may be used to wirelessly transmit video signals, for example, High-Definition-Television (HDTV) signals, between at least one video source and at least one video destination. In other embodiments, the methods, devices and/or systems disclosed herein may be used to transmit, in addition to or instead of the video signals, any other suitable signals, for example, any suitable multimedia signals, e.g., video and/or audio signals, between any suitable multimedia source and/or destination.

Although some demonstrative embodiments are described herein with relation to wireless communication including video information, some embodiments may be implemented to perform wireless communication of any other suitable information, for example, multimedia information, e.g., audio information, in addition to or instead of the video information. Some embodiments may include, for example, a method, device and/or system of performing wireless communication of A/V information, e.g., including audio and/or video information. Accordingly, one or more of the devices, systems and/or methods described herein with relation to video information may be adapted to perform wireless communication of A/V information.

### General Embodiments

The present invention is a method, circuit and system for transmission and reconstruction of a video block of a video frame within a video stream. According to some embodiments of the present invention, a video stream may be composed of sequential video frames, and each video frame may be composed of one or more video blocks including a set of pixels. Prior to transmission of the data associated with a video block, the video block data may be transformed into a set of transform (e.g. frequency) coefficients using a spatial to frequency transform such as a two dimensional discrete cosine transform. According to some embodiments of the present invention, only a portion or subset of the coefficients of a given video block may be transmitted. Selection of the subset of transform coefficients to be transmitted may be based on a characteristic of the video block. According to further embodiments of the present invention, only that subset to be transmitted may be calculated and transmitted.

According to further embodiments of the present invention, a first portion or subset of the coefficients may be transmitted using a first RF data link and a second portion or subset of the coefficients may be transmitted using a second RF link. One of the RF link may be more reliable than the other RF link. One set of coefficients may include more spatial information than another set of coefficients.

According to further embodiments of the present invention, selection of which subset of coefficients of a given block to transmit, or of which coefficients to transmit over a more reliable RF link and which subset to transmit over a less reliable link, may be performed by a coefficient selection module and may be based on a comparison of the given video block's pixel data against corresponding pixel data of one or more corresponding video blocks from one or more previous video frames stored in a buffer. According to further embodiments of the present invention where transmission of the video block data may not be absolutely in real time, a comparison of the given video block's data may also include a comparison against corresponding blocks from subsequent video frames. The comparison of a video block's data against the data of a corresponding video block in another frame may provide an indication as to the spatial/temporal deviation of the block relative to the corresponding video block in the previous frame—indicating whether the video block is static (i.e. substantially the same as) or dynamic (i.e. different from) relative to the corresponding block in the previous frame.

According to further embodiments of the present invention, a comparison of the given block against one or more corresponding blocks may produce an indicator of the spatial/temporal difference between the compared blocks. If this indicator (e.g. deviation value) is below a given threshold, indicating the block is relatively similar to the previous block, the coefficient selector module may select a first subset of coefficients for transmission. If the indicator is above the given threshold, indicating a dynamic block, the selector module may select a second subset of coefficients for transmission, which second set may be fully or partially overlapping with the first subset. According to some embodiments of the present invention, the first subset of coefficients may include less or more spatial data than the second subset of coefficients. According to further embodiments of the present invention, for video blocks associated with indicators indicating a deviation/difference above the threshold value, the second subset of coefficients may be selected for transmission over a more reliable RF link and the first subset may be selected for transmission over a second, less reliable, RF link.

According to further embodiments of the present invention, the threshold for designating a given block static or dynamic may itself be dynamically calculated. The threshold may, for example, be set lower for the given block if one or more of the given block's neighboring blocks have been designated as static. The threshold may be set higher if one of more of the given block's neighboring blocks have been designated as being dynamic.

According to further embodiments of the present invention, the coefficient selector module may dynamically select a subset of coefficients for transmission based on the deviation values of corresponding blocks. According to some embodiments of the present invention, there may be a functionally associated algorithm or method for increasing the robustness (e.g. size) of the subset of coefficients when there is an increasing deviation between corresponding blocks (e.g. full coefficient set transmission when blocks deviate completely from associated blocks). According to further embodiments of the present invention, when there is little deviation between corresponding blocks, it may be desirable to select a previously unselected subset of coefficients from a preceding corresponding block to integrate the formerly omitted data with the corresponding block data already selected.

According to some embodiments of the present invention, when a given video block is determined to be static, the coefficient selector may select coefficients which have were not transmitted for the corresponding block in the previous frame. An indicator indicating that this block is static may be transmitted along with the selected coefficients. An image reconstruction module (e.g. decoder and graphics circuit) on the receiver side (e.g. video sink) may receive the indicator and in response may keep the previously generated video block image and may use the received coefficients to augment or enhance the previously generated video block image. The coefficient set selected for a video block designated as static may also include coefficients previously transmitted for a corresponding block from the previous frame. These retransmitted coefficients, which were transmitted as part of the previously frame, may be used by the reconstruction module enhance the displayed video image by averaging corresponding coefficient values, thereby reducing possible image generating errors due to fidelity lose during transmission/reception. Coefficients selected for a video block designated as static and used by the reconstruction module to enhance a previously generated video image may be termed “complimenting coefficients”.

According to further embodiments of the present invention, there may be proportionality between the subset of coefficients selected and the reliability of the transmission. According to some embodiments of the present invention, the reliability may be based on the security of the transmission link and/or the type of transmitter used from a plurality of available transmitters. According to some embodiments of the present invention, an RF link with low reliability may transmit block transform coefficient data along unreliable bit streams which may not include data link protocols including data frames or flow/error control. According to further embodiments of the present invention, a reliable RF link may include data link protocols including the framing of coefficient data and flow/error control. According to some embodiments of the present invention, acknowledgments, negative acknowledgements, error detection and/or correction, and checksums may be implemented as features of a reliable RF link.

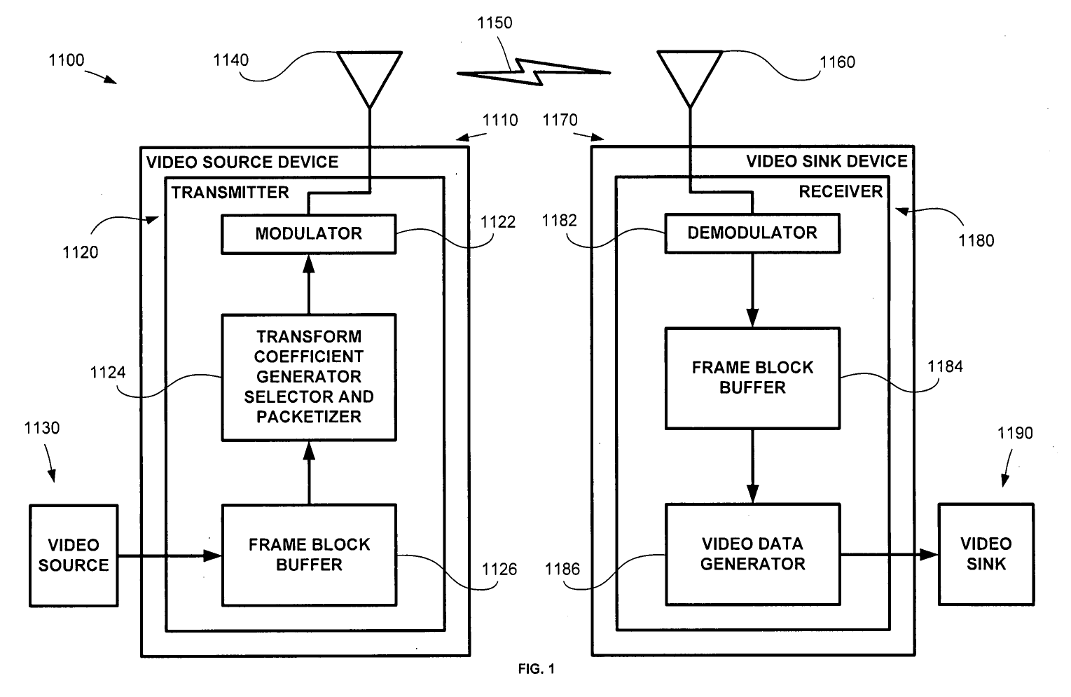

Turning now to FIG. 1, there is shown a functional block diagram of an exemplary video data transmitter/receiver pair according to some embodiments of the present invention where the transmitter includes a transform coefficient generator selector and packetizer block.

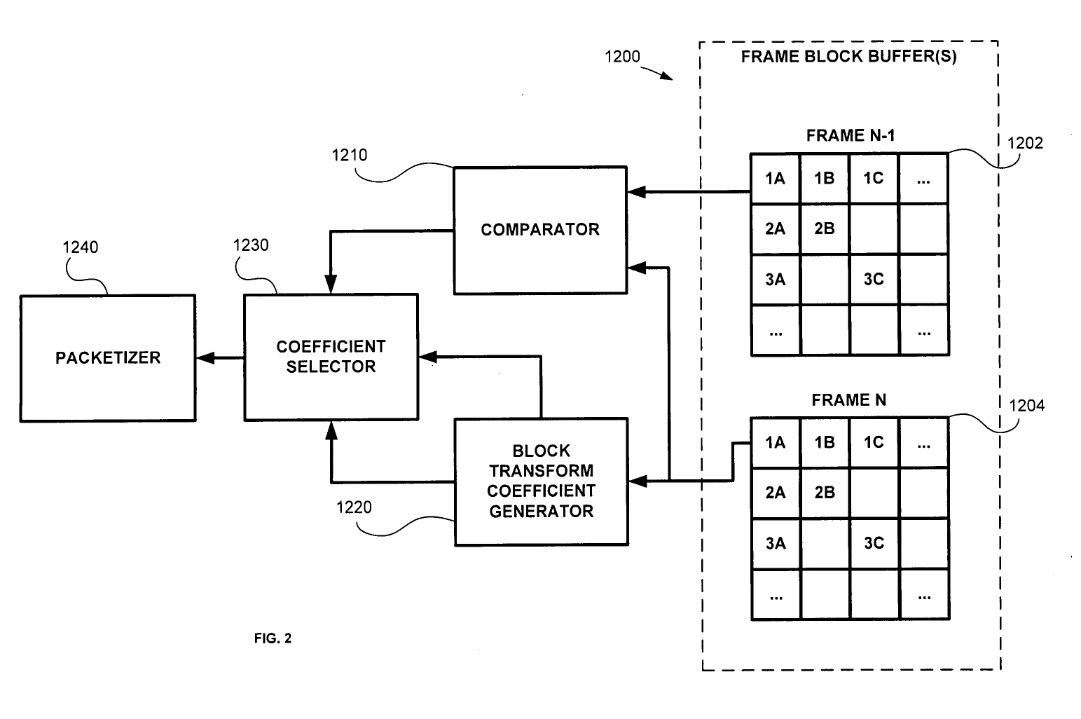

According to some embodiments of the present invention, a video source device (1110) may include a transmitter (1120) to transmit video data wirelessly to a functionally associated video sink device (1170) which may include a receiver (1180). According to further embodiments of the present invention, video source device (1110) may receive video data from a video source (1130) and may hold the data in a frame block buffer (1126). According to further embodiments of the present invention, before modulating the video data for transmission, blocks of video data may be processed through a transform coefficient generator, selector and packetizer (1124) which is shown in further detail in FIG. 2.

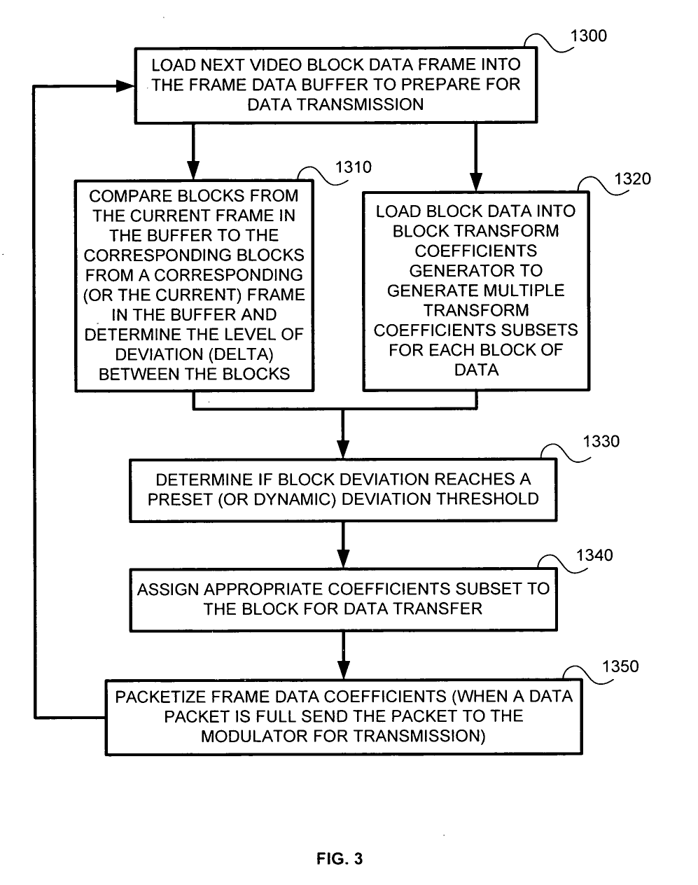

Turning now to FIG. 2, there is shown a functional block diagram of a transform coefficient selector and packetizer according to some embodiments of the present invention. The operation of the transform coefficient selector and packetizer may be described in view of FIG. 3 showing a flow chart including the steps of an exemplary method by which video data frame blocks may be assigned transform coefficients for transmission of video data.

According to some embodiments of the present invention, prior to packetizing (1350) video data for transmission, the data may be held in a frame block buffer (1200). According to further embodiments of the present invention, data blocks from the current frame may be sent to a block transform coefficient generator (1220) while concurrently being sampled at a comparator (1210). According to some embodiments of the present invention, the transform coefficients may be generated using a discrete cosine transform (DCT). According to further embodiments of the present invention (1320), multiple transform coefficients subsets may be generated for each block of data.

According to some embodiments of the present invention, blocks from the current frame in the buffer may be compared to the corresponding blocks from a corresponding frame in the buffer. According to further embodiments of the present invention (1310), the level of deviation (delta) between the blocks is determined and compared (1330) against a spatial/temporal deviation threshold value. According to some embodiments of the present invention, a coefficient selector (1230) may assign (1340) a coefficients subset to the given block for data transfer based on the comparison with the deviation threshold value. According to further embodiments of the present invention, a packetizer (1240) may packetize (1350) the selected video block coefficient subset to prepare for wireless transmission of data. According to further embodiments of the present invention, the completed data packets may be sent (1350) to an associated modulator for transmission.

Turning now to FIG. 3, there is shown a flow chart including the steps of an exemplary method by which video data frame blocks may be assigned transform coefficients for transmission of video data.

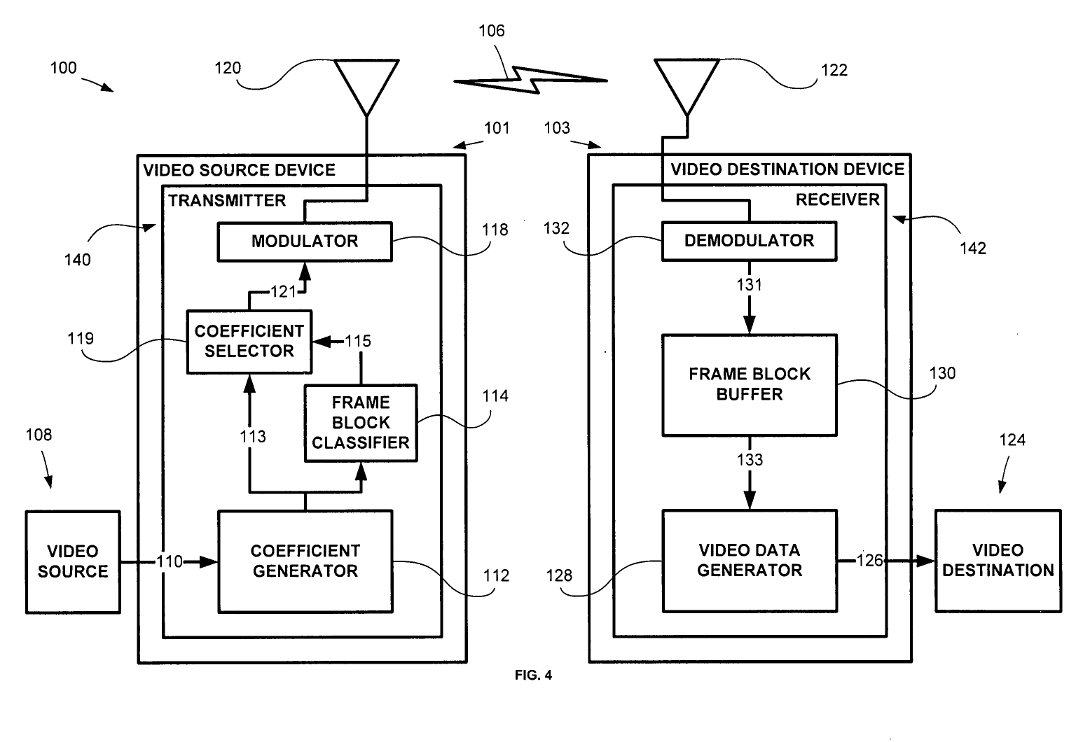

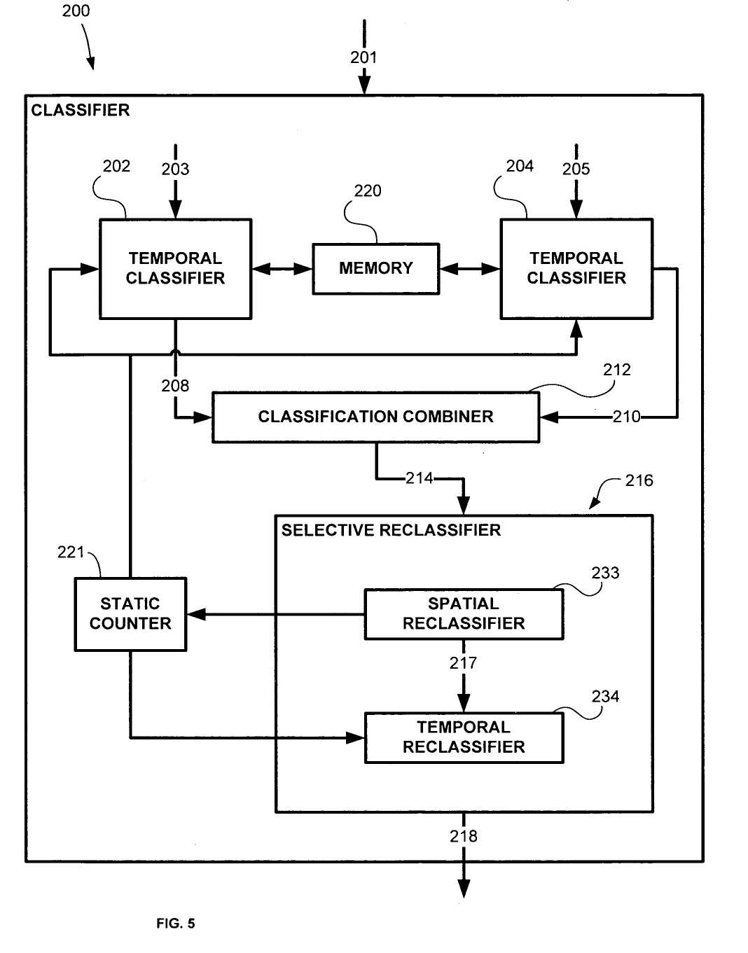

The following description of FIGS. 4, 5 & 6 relate to a specific pixel block classification as static/non-static embodiment of the present invention.

Some demonstrative embodiments include devices, systems and/or methods of classifying one or more pixel blocks of a video frame as either static or non-static.

In some embodiments, the classification of the pixel blocks may be implemented as part of the wireless communication of video data.

In some embodiments, a wireless communication link may have limited bandwidth, which may allow the transmission of only part of video data corresponding to a video frame. For example, the video frame may be divided into blocks of pixels and a transformation, e.g., a Discrete Cosine Transform (DCT), may be applied to the blocks, thereby to generate a plurality of transformation coefficients, e.g., a plurality of DCT coefficients. Due to the limited bandwidth of the wireless communication link, the values of some of the coefficients may not be transmitted and/or may be partially transmitted, e.g., the value of one or more DCT coefficients may be truncated or even not transmitted at all.

In some embodiments, the transmission of the partial video data may result in a reduction of quality of a video image reconstructed based on the partial video data. For example, some portions of the reconstructed video image, for example, portions having little or no variation between two or more consecutive frames (“static portions”), may suffer a relatively noticeable distortion and/or a flickering effect, e.g., due to the partial video data and/or due to noise over the communication link.

In some embodiments, the video frame may be divided into blocks of pixels, e.g., 8×8 blocks. A block of the video frame may be classified as either static or non-static.

In some embodiments, the classification may be performed based, for example, at least on at least one temporal classification value and/or at least one spatial classification value corresponding to the block.

In some embodiments, the temporal classification value may be based, for example, on a comparison between the values of one or more transformation coefficients corresponding to the block of the video frame, and previous values corresponding to the same block in one or more previous video frames.

In some embodiments, the spatial classification value may be based, for example, on the temporal classification value of the block and/or temporal classification values of one or more other blocks.

In some embodiments, the video data to be transmitted corresponding to the block may be determined based on the classification of the block. In some embodiments, values of a selected set of transformation coefficients corresponding to the block may be transmitted, wherein the set of transformation coefficients may be determined based on the classification of the block. For example, values of a first set of coefficients, e.g., including the most important coefficients, may be transmitted if the block is classified as non-static; and a second set of coefficients may be transmitted if the block is classified as static. In one embodiment, the transformation coefficients corresponding to the block may be assigned to a plurality of coefficient sets (phases). The values of the transformation coefficients of the first phase may be transmitted, for example, if the block is classified as non-static; while the values of the transformation coefficients of two or more phases may be transmitted, e.g., during a sequence of two or more frames, for example, if the block is classified as static during the sequence of two or more frames. In some configurations of the present invention, the values of a single phase may be transmitted even if the block is classified as static, e.g., while allowing noise reduction at the receiver by averaging, as described below.

In some embodiments, truncated values of one or more of the coefficients corresponding to the block may be transmitted and/or values of one or more of the coefficients corresponding to the block may not be transmitted, if the block is classified as non-static; while less-truncated, partially truncated, non-truncated or “full” values of one or more of the coefficients may be transmitted, if the block is classified as static.

Reference is made to FIG. 4, which schematically illustrates a wireless video communication system 100, in accordance with some demonstrative embodiments.

In some demonstrative embodiments, system 100 may include a wireless transmitter 140 to transmit a wireless video transmission 106, based on input video data 110. System 100 may also include any suitable video source 108 capable of generating video data 110, e.g., as described below.

In some demonstrative embodiments, system 100 may include a wireless receiver 142 to receive wireless video transmission 106, and to generate output video data 126, e.g., corresponding to video data 110. System 100 may also include any suitable video destination 124 capable of handling video data 126, for example, to render a video image corresponding to video data 110, e.g., as described below.

In some embodiments, wireless video transmission 106 may be transmitted over a wireless communication link, which may have limited bandwidth allowing the transmission of only part of video data 110.

In some embodiments, the transmission of partial video data may result in a reduction of quality of a video image reproduced, e.g., by video destination 124, based on the partial video data. For example, some portions of the reconstructed video image, for example, portions having little or no variation between two or more consecutive frames (“static portions”), may suffer a relatively noticeable distortion and/or a flickering effect, e.g., due to the partial video data and/or due to noise over the communication link.

In some embodiments, video data 110 may include video data of a sequence of video frames. Transmitter 140 may divide a video frame of video data 110 into a plurality of blocks of pixels. In one embodiment, each video frame may be divided into a plurality of square blocks of 8×8 pixels, e.g., including 64 pixels, each of which represented by three-color components. In other embodiments, the video frame may be divided according to any other suitable block scheme, e.g., including blocks of different sizes, different shapes, and the like.

In some embodiments, transmitter 140 may classify a block of the video frame as either static or non-static. In some embodiments, the classification may be performed based, for example, at least on at least one temporal classification value and/or at least one spatial classification value corresponding to the block, e.g., as described in detail below.

In some embodiments, the temporal classification value may be based, for example, on a comparison between the values of one or more transformation coefficients corresponding to the block of the video frame, and previous values corresponding to the same block in one or more previous video frames, e.g., as described in detail below.

In some embodiments, the spatial classification value may be based, for example, on the temporal classification value of the block and/or temporal classification values of one or more other blocks, e.g., as described in detail below.

In some embodiments, transmitter 140 may determine the video data to be transmitted corresponding to the block of pixels based, for example, on the classification of the block, e.g., as described below.

In some demonstrative embodiments, transmitter 140 may include a coefficient generator 112 to generate a plurality of transformation coefficients 113 corresponding to video data 110. For example, coefficient generator 112 may generate a predefined number of transformation coefficients 113 corresponding to the 8×8 block of pixels. In one embodiment, coefficient generator 112 may generate 192 transformation coefficients 113 corresponding to each 8×8 pixel block, e.g., including 64 coefficients corresponding to each of the three pixel color components as described below. In other embodiments, coefficient generator 112 may generate any other suitable number and/or type of transformation coefficients 113 corresponding to a pixel block of any suitable size and/or shape.

In some embodiments, coefficient generator 112 may generate coefficients 113 by applying a predefined coefficient-generation transformation to video signal 110. The coefficient-generation transformation may include, for example, a de-correlating transformation, e.g., a transformation from a spatial domain to, say, a frequency domain. In one example, the coefficient-generation transformation may include a discrete-cosine-transform (DCT) or a wavelet transformation e.g., as described in U.S. patent application Ser. No. 11/551,641, entitled “Apparatus and method for uncompressed, wireless transmission of video”, filed Oct. 20, 2006, and published May 3, 2007, as US Patent Application Publication US 2007-0098063 (“the '641 Application”), the entire disclosure of which is incorporated herein by reference. For example, coefficient generator 112 may perform the de-correlating transform on a plurality of color components, e.g., in the format Y-Cr-Cb, representing pixels of the pixel block, as described in the '641 Application. For example, the 8×8 block of pixels may be transformed into a DCT block of 192 coefficients 113, e.g., including three coefficients corresponding to each of the 64 pixels.

In some demonstrative embodiments, coefficients 113 may include transformation coefficients having different frequencies, for example, high-frequency transformation coefficients and low frequency transformation coefficients, e.g., as described by the '641 Application.

In some embodiments, the wireless communication link for transmitting wireless video transmission 106 may have limited bandwidth, which may allow the transmission of only part of transformation coefficients 113 corresponding to the pixel block, e.g., only part of the 192 transformation coefficients may be transmitted during a time period corresponding to the frame including the pixel block.

In some embodiments, video data 110 may include video data having a frame resolution of 1080×1920 pixels, each including three sub-pixels (“pixel colors”), and a frame frequency of 60 Hertz (Hz). Accordingly, if each 8×8 pixel block is represented by 192 transformation coefficients, then a data rate of 1080*1920*60/(8×8)*192≈375 Mega (M) transformation coefficients per second may be required. In some embodiments, the communication link may have a bandwidth, which may not allow transferring all the 192 transformation coefficients 113 corresponding to each pixel block of video data 110. For example, a bandwidth of 20 MHz may allow transferring only about 30-40, or any other suitable number, out of the 192 transformation coefficients corresponding to each 8×8 pixel block.

In some embodiments, transmitter 140 may classify a block of the video frame as either static or non-static. Based on the classification of the block, transmitter 140 may select the transformation coefficients corresponding to the block to be transmitted, e.g., as described below.

In some embodiments, transmitter 140 may include a block classifier 114 to classify the pixel block as either static or non-static; and a coefficient selector 119 to select, based on the classification 115 of the pixel block, a plurality of transformation coefficients to be transmitted as part of transmission 106.

In some embodiments, classifier 114 may classify the pixel block based, for example, at least on at least one temporal classification value and/or at least one spatial classification value corresponding to the pixel block.

In some embodiments, the temporal classification value may be based, for example, on a comparison between the values of one or more of transformation coefficients 113 corresponding to the block, and previous values corresponding to the same block in one or more previous video frames, e.g., as described below.

In some embodiments, the spatial classification value may be based, for example, on the temporal classification value of the block and/or temporal classification values of one or more other blocks, e.g., as described below.

In some embodiments, classifier 114 may determine at least one current temporal-difference value corresponding to the block of pixels based on a plurality of differences between a first plurality of values and a second plurality of values, respectively, wherein the first plurality of values include values corresponding to current pixel values of the block in a current frame, and wherein the second plurality of values include values corresponding to previous pixel values of the block in one or more previous video frames.

In some embodiments, the first plurality of values include values of a plurality of transformation coefficients 113 corresponding to the current pixel values, and the second plurality of values are based on previous values of the plurality of transformation coefficients 113 corresponding to the previous pixel values. In one embodiment, the plurality of transformation coefficients include at least a lowest-order spatial frequency coefficient of a plurality of DCT coefficients corresponding to a luminance pixel component, a lowest-order spatial frequency coefficient of a plurality of DCT coefficients corresponding to a blue-difference chroma pixel component, and a lowest-order spatial frequency coefficient of a plurality of DCT coefficients corresponding to a red-difference chroma pixel component, e.g., as described in detail below. In other embodiments, the transformation coefficients may include any other suitable transformation coefficients.

In some embodiments, classifier 114 may determine a current spatial-difference value corresponding to the block of pixels by applying a predefined averaging function to the current temporal-difference value corresponding to the block of pixels, and to at least one other current temporal-difference value corresponding to at least one other respective block of pixels. In one embodiment, the at least one other block of pixels includes at least two blocks located on a first side of the block of pixels and at least two blocks located on a second side opposite to the first side, e.g., as described below. In one embodiment, the predefined averaging function may include a weighted averaging function, which is based on two or more distances between the block and the two or more other blocks, respectively, e.g., as described below. In other embodiments, the averaging function may include any other averaging function, e.g., an averaging function applying the averaging factor zero to at least one of the one or more other blocks, or any other suitable averaging function.

In some embodiments, classifier 114 may classify the current pixel values of the block as either static or non-static based on the current spatial-difference value, as described in detail below.

In some embodiments, classifier 114 may determine a secondary current temporal-difference value corresponding to the block of pixels based on a difference between a value of a selected transformation coefficient of the plurality of transformation coefficients corresponding to the current pixel values of the block, and between a stored value, which is based on one or more transformation coefficient values corresponding to the previous pixel values of the block of pixels. Classifier 114 may classify the current pixel values of the block by determining a first classification of the current pixel values of the block as either static or non-static based on the current spatial-difference value; determining a second classification of the current pixel values of the block as either static or non-static based on the secondary current temporal-difference value; and classifying the current pixel values of the block as static only if both the first and second classifications are static, e.g., as described in detail below.

In some embodiments, classifier 114 may determine the second classification as static only if the secondary current temporal-difference value is lesser than a predefined threshold, and an index of the selected transformation coefficient is equal to a stored index.

In some embodiments, classifier 114 may determine a plurality of metrics corresponding, respectively, to the plurality of transformation coefficients corresponding to the current pixel values of the block. Classifier 114 may determine a difference between first and second metrics of the plurality of metrics, wherein the first metric is the greatest of the plurality of metrics, wherein the second metric corresponds to a transformation coefficient having an index equal to the stored index; and determine the selected transformation coefficient by selecting between a transformation coefficient corresponding to the greatest metric and the transformation coefficient having the index.

In some embodiments, classifier 114 may update the second plurality of values based on the first plurality of values. In one embodiment, classifier 114 may update the second plurality of values based on the classification of the current pixel values of the block of pixels. For example, classifier 114 may select an averaging factor based on the classification of the current pixel values of the block of pixels; and apply to the second plurality of values and the first plurality of values a weighted averaging function, which is based on the averaging factor.

In some embodiments, classifier 114 may select the averaging factor from a plurality of predefined factor values based on a number of times the block of pixels was previously classified as static, e.g., if the current pixel values of the block of pixels are classified as static.

In some embodiments, classifier 114 may select the averaging factor based on a comparison between the current spatial-difference value and one or more predefined threshold values, e.g., if the current pixel values of the block of pixels are classified as non-static.

In some embodiments, classifier 114 may selectively modify the classification of the current pixel values of the block based on the classification of one or more blocks of pixels adjacent to the block. For example, classifier 114 may selectively modify the classification of the current pixel values of the block, such that the current pixel values of the block are classified as static only if the block is part of a sequence of a predefined number of blocks, which are classified as static.

In some embodiments, coefficient selector 119 may select the transformation coefficients to be transmitted based on the classification 115 of the block, e.g., according to the coefficient selection scheme described below. In other embodiments, coefficient selector 119 may select the transformation coefficients to be transmitted based on any other suitable selection scheme.

In some embodiments, the transformation coefficients may be sorted according to a predefined criterion. For example, the 192 DCT coefficients corresponding to the 8×8 block may be sorted according to an importance criterion, e.g., according to the DCT frequency such that the DCT coefficients having the lowest frequencies are considered more important, or according to any other suitable criterion. In some embodiments, the transformation coefficients may be sorted also according to color, e.g., such that the Y-component coefficients are generally considered to be more important.

In some embodiments, the plurality of transformation coefficients, e.g., the 192 DCT coefficients may be assigned to a configurable number, denoted N, of sets (“phases”) of coefficients. For example, the value of N may be equal to or greater than one and equal to or less than five, or any other value. In one embodiment, each phase may include up to a predefined number (“fine budget”, “fbgt”) of coefficients starting from a configurable starting coefficients index (“start point”). The value of fbgt may be determined, for example, to be equal to or less than a number of transformation coefficients, which may be transmitted for each pixel block during a time period corresponding to the frame including the pixel block. A padding to fbgt members may be applied to a phase, for example, the last phase, e.g., to ensure identical phase size, if, for example, (start_point+fbgt−1)>191. The padding value may be configurable, e.g., zero. In one embodiment, the start point of the first group (“phase0”) may be constrained to zero.

In one example, N=5, and the five phases may be defined with fbgt=50, and the start points=[0, 40, 80, 120, 150]. According to this example, the first phase, phase0, may include the sorted coefficients 0-49; the second phase, phase1, may include the sorted coefficients 40-89; the third phase, phase2, may include the sorted coefficients 80-129; the fourth phase, phase3, may include the sorted coefficients 120-169; and the fifth phase, phase4, may include the sorted coefficients 150-191, with additional padding to fbgt=50 entries.

In some embodiments, the transformation coefficients belonging to a phase may be ordered within the phase according to any suitable criterion, for example, by applying a suitable predefined permutation function to the transformation coefficients belonging to the phase, such that the original order of the coefficients [a, b, c, d, e, f] is permuted to another order, e.g., [a, c, d, b, f, e].

In some embodiments, coefficient selector 119 may output selected transformation coefficient values 121 including values of transformation coefficients belonging to phase0, e.g., if the block is classified as non-static. However, coefficient selector 119 may output selected transformation coefficient values 121 including values of transformation coefficients belonging to a selected coefficient phase, denoted phase_{static}, e.g., including phase0 or another phase, for example, if the block is classified as static, e.g., as described below.

In some embodiments, coefficient selector 119 may select the phase phase_{static} corresponding to a block in a frame, based on the frame number and an index assigned to the block within the frame, for example, as follows:

[symbol]

(1)

wherein “mod” stands for modulo operation, and A denotes any suitable possibly configurable integer, e.g., A=2N; frame number denotes the value of the frame number (mod A), e.g., frame_number may receive the sequence of values 0, 1, 2, 3, 4, 5, 6, 7, 8, 9, 0, 1, 2, 3, 4, 5, 6, 7, 8, 9, 0, 1, 2 . . . , if A=10; dct_index denotes an index value assigned to the DCT block in the entire frame (mod A); and phases_table denotes a configurable phases table for selecting phase_{static}.

In one embodiment, the value of dct_index may be determined, for example, as follows, e.g., if A=10:

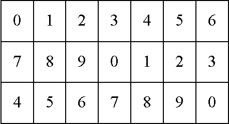

In another embodiment, the value of dct_index may have a predefined number for all the DCT blocks in the frame, or may be determined according to any other suitable scheme.

In one embodiment, the table phases_table may include A, e.g., 2N, configurable entries. For example, if A=10 and N=5, then phases_table=[0 1 2 3 4 0 1 2 3 4].

In one example, a block may be classified as non-static in a first frame; classified as static in a sequence of second, third, fourth, and fifth frames following the first frame; and classified as non-static in sixth and seventh frames following the fifth frame. According to this example, coefficient selector 119 may output transformation coefficient values 121 including values of transformation coefficients belonging to coefficient phase0 in the first frame; coefficient selector 119 may output transformation coefficient values 121 including values of transformation coefficients belonging to a sequence of four coefficient phases phase_{static}, e.g., selected according to Equation 1, in the second, third, fourth and fifth frames, respectively; and coefficient selector 119 may output transformation coefficient values 121 including values of transformation coefficients belonging to coefficient phase0 in the sixth and seventh frames.

In some demonstrative embodiments, transmitter 140 may also include an encoding and/or modulation module 118 to generate wireless transmission 106 based on the selected transformation coefficients 121 received from coefficient selector 119. Module 118 may encode and/or modulate coefficients 121 according to any suitable encoding and/or modulation scheme.

In some embodiments, module 118 may be configured to include in transmission 106 an indication of the value of the frame number (mod A) corresponding to the transmitted frame, e.g., to enable receiver 142 to determine the value of phase_{static}, e.g., as described below.

In some demonstrative embodiments, transmitter 140 may also include one or more antennas 120 to transmit transmission 106. Antennas 120 may include any suitable number of antennas, for example, a single antenna, multiple transmitting antennas, or any other configuration.

In some embodiments, modulator 118 may include any suitable modulation and/or RF modules to generate transmission 106 including selected transformation coefficients 121. Modulator 118 may implement any suitable transmission method and/or configuration to transmit transmission 106. In some demonstrative embodiments, modulator 118 may generate transmission 106 according to an Orthogonal-Division-Frequency-Multiplexing (OFDM) modulation scheme. According to other embodiments, modulator 118 may generate transmission 106 according to any other suitable modulation and/or transmission scheme.

In some demonstrative embodiments, transmission 106 may include a Multiple-Input-Multiple-Output (MIMO) transmission. For example, modulator 118 may modulate coefficients 121 according to a suitable MIMO modulation scheme.

In some demonstrative embodiments, wireless receiver 142 may receive transmission 106, e.g., via one or more antennas 122. Receiver 142 may demodulate and decode transmission 106, and generate output video signal 126, e.g., corresponding to video signal 110. Receiver 142 may implement any suitable reception method and/or configuration to receive transmission 106. In some embodiments, receiver 142 may receive, demodulate and/or decode transmission 106 according to an OFDM modulation scheme. In other embodiments, receiver 142 may receive, demodulate and/or decode transmission 106 according to any other suitable modulation and/or transmission scheme.

In some demonstrative embodiments, receiver 142 may include a decoder and/or demodulator module 132 to demodulate and/or decode transmission 106 into a plurality of transformation coefficients, e.g., corresponding to transformation coefficients 121. In one embodiment, module 132 may demodulate and/or decode transmission 106 according to any suitable MIMO demodulation scheme. In other embodiments, demodulator 132 may demodulate and/or decode transmission 106 according to any other suitable demodulation and/or decoding scheme.

In some embodiments, receiver 142 may also include a frame buffer 130 to buffer the transformation coefficients of at least one frame. For example, frame buffer 130 may buffer the transformation coefficients of all pixel blocks of the frame, e.g., as described below.

In some embodiments, frame buffer 130 may receive from module 132 input information 131 corresponding to each block of the blocks of a frame. In one embodiment, input information 131 may include for each DCT block of transmission 106, an indication on whether the block has been classified by classifier 114 as static or non-static; the set of transformation coefficients corresponding to the block as selected by selector 119, for example, a set of up to fbgt DCT coefficients belonging to the coefficient phase selected by selector 119, e.g., as described above; and a suitable quality-indication, e.g., indicating whether the values of the DCT coefficients have been received by module 132 in good or bad quality. Frame buffer 130 may determine the coefficient phase to which the received DCT coefficients belong, for example, using Equation 1 based on the received frame number.

In some embodiments, frame buffer 130 may store, e.g., for each block, values of all coefficients corresponding to the block, e.g., all 192 DCT coefficients corresponding to each block. In some embodiments, less than all of the coefficients may be stored, e.g., due to any hardware constraints, and the like. The stored values of the coefficients may be initialized to zero. Frame buffer 130 may also maintain at least one phase repetition counter corresponding to each of the blocks. Frame buffer 130 may initialize a phase repetition counter corresponding to a block, e.g., every time the block is identified as non-static; and may increment the phase repetition counter, e.g., every time the block is identified as static. In one embodiment, the number of repetition counters corresponding to each block may be equal to the number of phases, e.g., five repetition counters may be implemented if N=5, such that frame buffer 130 may increment the appropriate phase repetition counter each time a specific phase enters frame buffer 130, and initialize all the counters when the block is identified as non-static.

In some embodiments, frame buffer 130 may cumulatively assemble the plurality of coefficients corresponding to a block, for example, during a sequence of frames in which the block is classified as static, e.g., by accumulating up to all of the 192 DCT coefficients corresponding to the block as described below. As a result, extensive static image refinement and/or channel noise reduction by averaging may be achieved.

In some embodiments, frame buffer 130 may assemble the transformation coefficients corresponding to the block, which is classified as static, using any suitable averaging function, for example, according to the following “alpha filtering” equation:

[symbol]

(2)

wherein Input_{buffer}(n) denotes a value of a transformation coefficient received via input 131 with relation to an n-th frame; mem_{buffer}(n) denotes a value maintained by frame buffer 130 in n-th frame corresponding to the transformation coefficient; mem_{buffer}(n+1) denotes an updated value corresponding to the transformation coefficient to be maintained by frame buffer 130 with relation to the frame n+1: and α_{buffer} denotes constant (.( In one embodiment, the value of α_{buffer} may be selected from a configurable table, which may be accessed based on the appropriate phase repetition counter. For example: α_{buffer}=[1, ½, ⅓, ¼, ⅕, . . . ]. In other embodiments, the value of α_{buffer} may be configured and/or selected according to any other suitable scheme.

In some embodiments, if a block is classified as non-static in a frame, then frame buffer 130 input information may include the phase0 transformation coefficients corresponding to the block, e.g., as described above. Frame buffer 130 may directly store the phase0 transformation coefficients corresponding to the block, e.g., without applying the alpha filtering function. Frame buffer 130 may also initialize all phase repetition counters corresponding to the block. In one embodiment, frame buffer 130 may also initialize, e.g., to zero, the values of all the transformation coefficients not belonging to phase0. In another embodiment, frame buffer 130 may not be required to initialize the values of the transformation coefficients, for example, frame buffer 130 may be configured to output the value zero for each of the transformation coefficients not belonging to phase0, even if the block is classified as static, e.g., when the appropriate phase repetition counters are zero.

In some embodiments, frame buffer 130 may be capable of masking transmission errors, which may occur in transmission 106. For example, if frame buffer 130 receives input information 131 indicating that a block is classified as “bad”, then frame buffer 130 may not update the maintained values and/or repetition counters of the transformation coefficients corresponding to the “bad” block.

In some embodiments, frame buffer 130 may output the set of transformation coefficients 133 corresponding to each block of each frame, e.g., including 192 values (of which some may be zero) corresponding to each block. The set of transformation coefficients 133 outputted by frame buffer 130 may be substantially identical to the coefficient values stored by frame buffer 130 of the current frame, e.g., excluding any initialized values of transformation coefficients as described above.

In some demonstrative embodiments, receiver 142 may also include a video data generator 128, to generate video signal 126 based on the set of coefficients 133 received from buffer 130.

In some embodiments, video data generator 128 may apply an inverse of the coefficient-generating transformation applied by coefficient generator 112, e.g., an inverse wavelet, an Inverse Discrete Cosine Transform (IDCT), or any other suitable transformation, e.g., as described in the '641 application.

In some demonstrative embodiments, video source 108 and transmitter 140 may be implemented as part of a video source device 101, e.g., such that video source 108 and transmitter 140 are enclosed in a common housing, packaging, or the like. In other embodiments, video source 108 and transmitter 140 may be implemented as separate devices.

In some demonstrative embodiments, video destination 124 and receiver 142 may be implemented as part of a video destination device 103, e.g., such that video destination 124 and receiver 142 are enclosed in a common housing, packaging, or the like. In other embodiments, video destination 124 and receiver 142 may be implemented as separate devices.

In some demonstrative embodiments, transmitter 140 may include or may be implemented as a wireless communication card, which may be attached to video source 108 externally or internally.

In some demonstrative embodiments, receiver 142 may include or may be implemented as a wireless communication card, which may be attached to video destination 124 externally or internally.

In some demonstrative embodiments, video signal 110 may include a video signal of any suitable video format. In one example, signal 110 may include a HDTV video signal, for example, a compressed or uncompressed HDTV signal, e.g., in a Digital Video Interface (DVI) format, a High Definition Multimedia Interface (HDMI) format, a Video Graphics Array (VGA), a VGA DB-15 format, an Extended Graphics Array (XGA) format, and their extensions, or any other suitable video format. Video source 108 may include any suitable video software and/or hardware, for example, a portable video source, a non-portable video source, a Set-Top-Box (STB), a DVD, a digital-video-recorder, a game console, a PC, a portable computer, a Personal-Digital-Assistant, a Video Cassette Recorder (VCR), a video camera, a cellular phone, a television (TV) tuner, a photo viewer, a media player, a video player, a portable-video-player, a portable DVD player, an MP-4 player, a video dongle, a cellular phone, and the like. Video destination 124 may include, for example, a display or screen, e.g., a flat screen display, a Liquid Crystal Display (LCD), a plasma display, a back projection television, a television, a projector, a monitor, an audio/video receiver, a video dongle, and the like. In other embodiments, video signal 110 may include any other suitable video signal, and/or video source 108 and/or video destination 124 may include any other suitable video modules.

In some embodiments, types of antennas that may be used for antennas 120 and/or 122 may include, but are not limited to, internal antenna, dipole antenna, omni-directional antenna, a monopole antenna, an end fed antenna, a circularly polarized antenna, a micro-strip antenna, a diversity antenna and the like.

Reference is now made to FIG. 5, which schematically illustrates a block classifier 200, in accordance with some demonstrative embodiments. In one embodiment, block classifier 200 may perform the functionality of block classifier 114 (FIG. 4).

In some embodiments, block classifier 200 may receive a plurality of transformation coefficients 201, e.g., DCT coefficients, corresponding to blocks of pixels of video frames. For example, coefficients 201 may include transformation coefficients 113 (FIG. 4).

In some embodiments, block classifier 200 may classify a plurality of current pixel values of a block of pixels, e.g., pixel values of an 8×8 block of pixels or any other suitable block of pixels, in a current video frame, as either static or non-static, based at least on values of coefficients 201 corresponding to the block of pixels, as described below.

In some embodiments, block classifier 200 may include a first temporal classifier 202 to determine a first temporal classification value 208 representing a temporal classification of the current pixel values of the block, as either static or non-static, based on a comparison of values of a first plurality of DCT coefficients 203 corresponding to the current pixel values and a plurality of values corresponding to previous values of the DCT coefficients in one or more previous video frames, e.g., as described in detail below.

In one embodiment, the first plurality of DCT coefficients 203 may include three DCT coefficients corresponding to the pixel block, e.g., a lowest-order spatial frequency coefficient of a plurality of DCT coefficients corresponding to a luminance pixel component (the “Y” pixel component), a lowest-order spatial frequency coefficient of a plurality of DCT coefficients corresponding to a blue-difference chroma pixel component (the “Cb” pixel component), and a lowest-order spatial frequency coefficient of a plurality of DCT coefficients corresponding to a red-difference chroma pixel component (the “Cr” pixel component). In other embodiments, any other suitable plurality of coefficients may be used, e.g., including more than three transformation coefficients and/or any other set of transformation coefficients. In one example, the plurality of transformation coefficients may include all 192 DCT coefficients corresponding to the block. In another example, the plurality of transformation coefficients may include any portion and/or combination of the 192 DCT coefficients corresponding to the block. In yet another example, the plurality of transformation coefficients may include any suitable number of the lowest-order spatial frequency coefficient, e.g., at least the first and second lowest-order spatial frequency coefficients corresponding to each of the Y, Cb and Cr pixel components. In yet another example, the plurality of transformation coefficients may include different numbers of coefficients corresponding the Y, Cb and Cr pixel components, e.g., including a first number of coefficients corresponding to the Y pixel component, which is equal to or greater than second and/or third numbers of coefficients corresponding to the Cb and Cr pixel components, respectively.

In some embodiments, classifier 202 may store and/or update the values of coefficients 203 in a memory 220, e.g., as described below. Memory 220 may include any suitable memory or buffer. For example, the values of memory 220 may be initialized to zero, or any other suitable value.

In some embodiments, classifier 202 may determine a difference value, denoted err(n) corresponding to an n-th video frame, between the values of coefficients 203 corresponding to the block in the n-th video frame, and between values of memory 220, which are based on previous values of the plurality of transformation coefficients. For example, classifier 202 may determine the difference value err(n) as follows:

[symbol]

(3)

wherein dc₁(n) denotes the current value of the Y pixel component, dc₂(n) denotes the current value of the Cr pixel component, and dc₃(n) denotes the current value of the Cb pixel component; and wherein mem₁(n) denotes a stored value corresponding to the Y pixel component, mem₂(n) denotes a stored value corresponding to the Cr pixel component, and mem₃(n) denotes a stored value corresponding to the Cb pixel component. For example, as described above the values mem₁(1), mem₂(1), and mem₃(1) corresponding to the first video frame may be initialized to zero.

A video image may hold uniform static and non-static regions. In some embodiments, classifier 202 may utilize a spatial filtering scheme, which relates to the one or more additional pixel blocks of the current frame, to spatially adjust the difference value err(n). In one example, classifier 202 may apply the following weighted spatial filtering function, denoted h_{-2,-1,0,1,2}, e.g., to adjust the difference value err (n) corresponding to the block based on the values of four other blocks, e.g., two blocks on the right hand side and two blocks on the left hand side of the block:

[symbol]

(4)

wherein w1, w2, w3, w4, and w5 denote five configurable weight values, e.g., 2, 4, 8, 4, and 2, respectively, or any other suitable value, e.g., zero or non-zero.

In some embodiments, classifier 202 may spatially adjust the difference value err(n) corresponding to the block in the current frame, based on difference values of four blocks adjacent to the block, e.g., two blocks on the right hand side of the block and two blocks on the left hand side of the block. For example, classifier 202 may determine spatial difference value, denoted, err_filtₖ, corresponding to a k-th block, e.g., as follows:

[symbol]

(5)

In other embodiments, any other suitable spatial filtering function may be used, e.g., having a different number of weights and/or relating to any other suitable configuration of blocks. For example, the spatial filtering function may relate to less than four additional blocks, e.g., a single other block, two other blocks and the like; more than four additional blocks; one or more blocks at a different location to the block, e.g., on top of the block or below the block; one or more blocks not directly neighboring the block, e.g., blocks separated from the block by one or more other blocks, and the like. In other embodiments, any other averaging function h may be used, e.g., an averaging function applying the averaging weight of zero to at least one of the one or more other blocks, or any other suitable averaging function.

In some embodiments, classifier 202 may determine the first temporal classification 208 of the current pixel values of the block as either static or non-static based, for example, on spatial difference value err_filtₖ corresponding to the current pixel values of the block. For example, classifier 202 may determine the first classification 208 of the current pixel values of the block as static, e.g., if the spatial difference value err_filtₖ corresponding to the current pixel values of the block is less than a predefined threshold, denoted Th1; and as non-static, e.g., if the spatial difference value err_filtₖ corresponding to the current pixel values of the block is equal to or greater than the threshold Th1. The threshold Th1 may be determined, for example, based on a lab simulation with relation to relatively “noisy” video data, e.g., static or substantially static video data with dithering noise, VGA noise, and the like, and/or using any other suitable method or calculation.

In some embodiments, classifier 202 may determine the values of mem₁(n+1), mem₂(n+1), and mem₃(n+1) to be used with respect to the succeeding (n+1)-th video frame based on the stored memory values mem₁(n), mem₂(n), and mem₃(n) and based on the current values dc₁(n), dc₂(n), and dc₃(n) corresponding to the current pixel values, e.g., as described below.

In some embodiments, classifier 202 may determine the values of mem₁(n+1), mem₂(n+1), and mem₃(n+1) using an averaging factor, denoted α, e.g., as follows:

[symbol]

(6)

The values of memᵢ(1) corresponding to the first fame may be initialized, for example, as memᵢ(1)=0 or using any other initialization scheme and/or values.

In some embodiments, the averaging factor α may include a value, e.g., which may be selected by classifier 202, for example, based on the classification 208 of the current pixel values of the block, e.g., as described below. In other embodiments, the averaging factor α may include any other suitable factor.

In some embodiments, the averaging factor α may be time varying. According to further embodiments of the present invention, the averaging factor α may be high for a first frame and progressively decline (e.g. an averaging factor of 1/n where n is the frame index).

In some embodiments, if the classifier 202 classifies the block as static, then classifier 202 may select the averaging factor α from a plurality of predefined factor values based on a number of times the block has previously been classified as static. Classifier 202 may include, for example, a suitable static-repetition counter 221 to count the number of successive frames in which classifier 200 has classified the block as static, e.g., as described below. For example, classifier 202 may select the averaging factor α from a table, e.g., stored in memory 220 or in any other suitable memory, including a predefined set of values, e.g., wherein the predefined value of the averaging factor α decreases as the number of times the block has previously been classified as static increases, or wherein the value of the averaging factor α is predefined according to any other suitable scheme.

In some embodiments, if the classifier 202 classifies the block as non-static, then classifier 202 may select the averaging factor α based on a comparison between the current spatial difference value err_filtₖ and one or more additional predefined threshold values, e.g., which are greater than the threshold value Th1. For example, when a static picture is replaced (“scene change”), e.g., as part of a slide-show presentation video or the like, it may takes several frames until the “old” values are completely “wiped” out from memory 220, e.g., if a relatively low averaging factor α is used. This situation may result in a latency of one or more frames until classifier 202 classifies blocks as static, after the scene change. Accordingly, the value of the averaging factor α may be increased, for example, as the spatial difference value err_filtₖ increases, e.g., in order to reduce such latency. For example, classifier 202 may select a first predefined value of averaging factor α, e.g., if the spatial difference value err_filtₖ is equal to or greater than the threshold Th1, and less than a second predefined threshold, denoted Th2; and select a second predefined value of averaging factor α, e.g., if the spatial difference value err_filtₖ is equal to or greater than the threshold Th2, which may indicate a scene change. For example, classifier 202 may select the value of the averaging factor α, e.g., according to the following mechanism:

```
If err_filtₖ < Th1 % static mode
    Select α from table
Else if Th1 <= err_filtₖ < Th2 % regular non-static mode
    Select α 1 (~⅓)
Else % very large error non-static mode (“Scene change”)
    Select α 2 (~1)
End
```

wherein the symbol “˜” represents the phrase “approximately equal to”.

In some embodiments, classifier 202 may halt the updating of the values memᵢ in memory 220, e.g., by using the averaging factor α=0 or any other relatively low value, or by using the previously-selected value of α, for one or more video frames, based on any suitable criterion. For example, classifier 202 may halt the updating of the values memᵢ in memory 220 corresponding to a block, which has been determined to be static for a predefined number of successive video frames, e.g., five consecutive video frames. Classifier 202 may determine the number of successive frames the block has been determined as static using based, for example, on static-repetition counter 221. The halting of the updating may prevent, for example, continuous determination of a block as static, e.g., in very slowly-changing video image. Classifier 202 may resume the updating of the values memᵢ in memory 220 corresponding to the block, for example, upon determining that the block has changed to be non-static.

In some embodiments, block classifier 200 may include a second temporal classifier 204 to determine a second temporal classification value 210 representing a temporal classification of the current pixel values of the block, as either static or non-static, based on a difference between a value of a selected DCT coefficient of a plurality of DCT coefficients 205 corresponding to the current pixel values of the block, and between a stored value, which is based on one or more transformation coefficient values corresponding to the previous pixel values of the block.

In one embodiment, the plurality of DCT coefficients 205 may include sixty-four DCT coefficients corresponding to the pixel block, e.g., a DCT coefficient corresponding to the Y pixel component of each one of the sixty-four pixels in the 8×8 pixel block. In other embodiments, any other suitable plurality of coefficients may be used, for example, all 192 coefficients or any part thereof corresponding to the 8×8 pixel block.

Although some embodiments relate to a block classifier, e.g., classifier 200, including first and second temporal classifiers, e.g., classifiers 202 and 204, other embodiments may relate to a classifier including any other suitable number of temporal classifiers, for example, a single temporal classifier. One embodiment may include, for example, a block classifier including only one temporal classifier, e.g., temporal classifier 202. For example, coefficients 203 may include a relatively large number, for example, at least five, lowest-order spatial frequency coefficients corresponding to each of the Y, Cb and Cr pixel components. In one embodiment, coefficients 203 may at least half of the coefficients corresponding to each of the Y, Cb and Cr pixel components, for example, at least three-quarters of the coefficients corresponding to each of the Y, Cb and Cr pixel components, e.g., substantially all of the coefficients corresponding to each of the Y, Cb and Cr pixel components.

In some embodiments, classifier 204 may store and/or update an index representing the selected DCT coefficient and the value of the selected DCT coefficient in memory 220, e.g., as described below. Although some embodiments are described herein with storing the coefficients utilized by classifiers 202 and 204 in a common memory 220, in other embodiments some or all of the coefficients utilized by classifiers 202 and 204 using different memories.

In some embodiments, classifier 204 may determine a difference value, denoted err′(n) corresponding to an n-th video frame, between the value, denoted coeff(n), of a coefficient of coefficients 205 corresponding to the index stored in memory 220, and between a value, denoted mem(n), of the coefficient stored in memory 220. For example, classifier 204 may determine the difference value err′(n) as follows:

[symbol]

(7)

In some embodiments, classifier 204 may utilize a spatial filtering scheme, which relates to the one or more additional pixel blocks of the current frame, to spatially adjust the difference value err′(n). In one example, classifier 204 may apply a weighted spatial filtering function h′, e.g., having the weights described above or having any other suitable weights, to adjust, for example, the difference value err′(n) corresponding to the block based on the values of four other blocks.

In some embodiments, classifier 204 may spatially adjust the difference value err′(n) corresponding to the block in the current frame, based on difference values of four blocks adjacent to the block, e.g., two blocks on the right hand side of the block and two blocks on the left hand side of the block. For example, classifier 204 may determine spatial difference value, denoted, err_filt′ₖ, corresponding to the k-th block, e.g., as follows:

[symbol]

(8)

In other embodiments, any other suitable spatial filtering function may be used, e.g., having a different number of weights and/or relating to any other suitable configuration of blocks. For example, the spatial filtering function may relate to less than four additional blocks, e.g., a single other block, two other blocks and the like; more than four additional blocks; one or more blocks at a different location to the block, e.g., on top of the block or below the block; one or more blocks not directly neighboring the block, e.g., blocks separated from the block by one or more other blocks, and the like.

In some embodiments, classifier 204 may reselect the DCT coefficient corresponding to a block, e.g., every video frame, based on the current pixel values of the block. For example, classifier 204 may be capable of determining a plurality of metrics corresponding, respectively, to the plurality of DCT coefficients 205 of the current pixel values of the block; determining a difference between first and second metrics of the plurality of metrics, wherein the first metric is the greatest of the plurality of metrics, and wherein the second metric corresponds to a DCT coefficient having an index equal to the stored index; and determining the selected DCT coefficient by selecting between a DCT coefficient corresponding to the greatest metric and the DCT coefficient having the index, e.g., as described below.

In some embodiments, classifier 204 may determine the following metric values, denoted metricⱼ, corresponding to the plurality of coefficients 205, e.g., wherein j=1 . . . 64 if coefficients 205 include the 64 coefficients described above:

[symbol]

(9)

wherein coeffⱼ denotes the j-th coefficient, and wherein constⱼ denotes a predefined value corresponding to the j-th coefficient. For example, the values of constⱼ may be stored in a predefined table. In one embodiment, different constⱼ values may be assigned to different coefficients. For example, the constⱼ values corresponding to the higher spatial-frequency coefficients may be greater than the constⱼ values corresponding to the lower spatial-frequency coefficients. In other embodiments, any other suitable constⱼ values may be assigned to the coefficients, e.g., such that part or all of the constⱼ values have the same value and/or wherein one or more of the constⱼ values are zero.

In some embodiments, classifier 204 may compare between the metric values of the coefficient having the highest metric value, denoted, coeffₘₐₓ, and between the metric of the coefficient corresponding to the index stored in memory 220, denoted coeffₘₑₘ.

In one embodiment, classifier 204 may select the index of the coefficient coeffₘₑₘ, for example, if:

[symbol]

(10)

wherein TH_{metric} denotes a predefined metric-difference threshold value.

Classifier 204 may select the index of the coefficient coeffₘₐₓ, for example, if:

[symbol]

(11)

In some embodiments, classifier 204 may store in memory 220 the index zero or any other index in the first, e.g., initialization, video frame.

In some embodiments, classifier 204 may determine the second temporal classification 210 of the current pixel values of the block as either static or non-static based, for example, on the spatial difference value err_filt′ₖ corresponding to the current pixel values of the block and on the index of the selected coefficient corresponding to the current pixel values of the block. For example, classifier 204 may determine the second classification 210 of the current pixel values of the block as static, e.g., only if the spatial difference value err_filt′ₖ corresponding to the current pixel values of the block is lesser than a predefined threshold, denoted Th1′, and an index of the selected coefficient corresponding to the current pixel values of the block is equal to the index stored by memory 220.

In some embodiments, classifier 204 may update the value of the coefficient coeffₘₑₘ stored in memory 220, based on the current value of the currently selected coefficient coeff(n) or based on the current value of the currently selected coefficient and the index representing the currently selected coefficient.

In some embodiments, classifier 204 may update the value of coeffₘₑₘ using an averaging factor, denoted α′, e.g., as follows:

[symbol]

(12)

In some embodiments, the averaging factor α′ may include a value, e.g., which may be selected by classifier 204, for example, based on the classification 210 of the current pixel values of the block, e.g., as described below. In other embodiments, the averaging factor α′ may include any other suitable factor.

In some embodiments, if the classifier 204 classifies the block as static, then classifier 204 may select the averaging factor α′ from a plurality of predefined factor values based on a number of times the block has previously been classified as static, e.g., based on the value of static-repetition counter 221. For example, classifier 204 may select the averaging factor α′ from a table, e.g., stored in memory 220 or any other suitable memory, including a predefined set of values, e.g., wherein the predefined value of the averaging factor α′ decreases as the number of times the block has previously been classified as static increases, or wherein the value of the averaging factor α is predefined according to any other suitable scheme.

In some embodiments, if the classifier 204 classifies the block as non-static, then classifier 204 may select the averaging factor α′ based on a comparison between the current spatial difference value err_filt′ₖ and one or more additional predefined threshold values, e.g., which are greater than the threshold value Th1′. For example, the value of the averaging factor α′ may be increased, e.g., as the spatial difference value err_filt′ₖ increases. For example, classifier 204 may select a first predefined value of averaging factor α′, e.g., if the spatial difference value err_filtₖ is equal to or greater than the threshold Th1′, and less than a second predefined threshold, denoted Th2′; select a second predefined value of averaging factor α′, e.g., if the spatial difference value err_filt′ₖ is equal to or greater than the threshold Th2′; and/or select a third predefined value of averaging factor α′, e.g., if the index of the coefficient has changed. For example, classifier 204 may select the value of the averaging factor α′, e.g., according to the following mechanism:

```
If (err_filt′ < TH1′ & same_index) % static mode
    Select alpha1 from memory table
Else if (TH1′ <= err_filt′ < TH2′ & same_index) % regular non-static
mode
    Select alpha2 from a configurable register (~⅓ for example)
Else if (err_filt′ >= TH2′ & same_index) % very large error (“Scene
change mode”)
    Select alpha3 (~1 for example)
Else if (NOT(same_index)) % the index of the coefficient has changed
    Select alpha4 (~1 for example)
End
```

In some embodiments, classifier 204 may halt the updating of the value of coeffₘ in memory 220, e.g., by using the averaging factor α′=0. any other suitable relatively low value, or using the previously-selected value of α, for one or more video frames, based on any suitable criterion. For example, classifier 204 may halt the updating of the value coeffₘ in memory 220 corresponding to a block, which has been determined to be static for a predefined number of successive video frames, e.g., five consecutive video frames. Classifier 204 may determine the number of successive frames the block has been determined as static using based, for example, on static-repetition counter 221. The halting of the updating may prevent, for example, continuous determination of a block as static, e.g., in very slowly-changing video image. Classifier 204 may resume the updating of the value coeffₘ in memory 220 corresponding to the block, for example, upon determining that the block has changed to be non-static.

In some embodiments, classifier 204 may optionally determine classification 210 to be static, e.g., regardless of the value of err_filt′ₖ, for example, if all coefficients 205, which have a value, constᵢ≠0 have an absolute value that is less than a predefined threshold. In other embodiments, classifier 204 may determine classification 210 based on the value of err_filt′ₖ, e.g., even if all coefficients 205, which have a value, constᵢ≠0 have an absolute value that is less than the predefined threshold.

In some embodiments, the classifications 208 and 210 may include a binary value, for example, a value of one, e.g., representing a static classification; and a value of zero, e.g., representing a non-static classification.

In some embodiments, block classifier 200 may also include a classification combiner 212 to determine a classification 214 of the current pixel values of the block based on a combination of classifications 208 and 210 corresponding to the current pixel values of the block. For example, classification combiner may classify the current pixel values of the block as static only if both the classifications 208 and 210 are static. For example, classification combiner 212 may include a logical “AND” module to perform a logical AND operation on classifications 208 and 210.

In some embodiments, block classifier 200 may include a selective re-classifier 216 to selectively modify the classification 214 of the current pixel values of the block based on the classification 214 of one or more blocks of pixels adjacent to the block. Although some embodiments are described herein with reference to selectively modifying the classification 214 of the current pixel values of the block based on the classification 214 of one or more blocks of pixels adjacent to the block, other embodiments may include selectively modifying the classifications 208 and/or 210 of the current pixel values of the block based on the classifications 208 and/or 210, respectively of one or more blocks of pixels adjacent to the block.

In one embodiment, re-classifier 216 may include a spatial re-classifier 233 to selectively modify the classification 214 of the current pixel values of the block, such that the current pixel values of the block are classified by re-classifier 216 as static only if the block is part of a sequence of a predefined number of blocks, which are classified as static, e.g., as described below. In other embodiments, re-classifier 216 may selectively modify the classification 214 of the current pixel values of the block based on any other suitable criterion.

In some embodiments, spatial re-classifier 233 may reclassify the classification 214 of the current pixel values of the block, from static to non-static, for example, if the block does not have at least N−1 horizontal neighboring blocks, which are also classified as static. In other embodiments, spatial re-classifier 233 may reclassify the classification 214 of the current pixel values of the block, from static to non-static in accordance with any other suitable re-classification scheme, for example, any suitable one or more dimensional scheme relating to one or more vertical and/horizontal blocks. In one example, N=3. In one non-limiting exemplary scenario, spatial re-classifier 233 may determine classifications 217 corresponding to the following 20 pixel blocks, based on the following classifications 214:

| | Number of block in row | | | | | | | | | | | | | | | | | | | |
|---|---|---|---|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 | 16 | 17 | 18 | 19 |
| Classif. | 1 | 1 | 1 | 0 | 1 | 1 | 1 | 1 | 0 | 1 | 1 | 0 | 1 | 0 | 1 | 1 | 1 | 0 | 1 | 1 |
| 214 | | | | | | | | | | | | | | | | | | | | |
| Classif. | 1 | 1 | 1 | 0 | 1 | 1 | 1 | 1 | 0 | 0 | 0 | 0 | 0 | 0 | 1 | 1 | 1 | 0 | 0 | 0 |
| 217 | | | | | | | | | | | | | | | | | | | | |

In some embodiments, classifier 200 may update the value of counter 221 corresponding to the block based on classification 217 of the block. For example, classifier 200 may increase the value of counter 221 corresponding to the block, e.g., if classification 217 is static; or reset the value of counter 221 corresponding to the block, e.g., if classification 217 is non-static.

In some embodiments, selective re-classifier 216 may optionally include a temporal re-classifier 234 to selectively re-classify classification 217 corresponding to a block based on the number of times the block has been previously classified as static. For example, temporal re-classifier 234 may determine the classification 218 of a block as static only if classification 217 of the block is static and the block has been previously classified as static for a predefined number of frames, e.g., in order to cancel temporally sporadic classification of the block as static. For example, re-classifier 234 may determine classification 218 of the block to be static, for example, only if the value of counter 221 corresponding to the block is equal to or greater than a predefined threshold. In other embodiments, classification 218 may include classification 217, e.g., if temporal re-classifier 234 is not implemented.

In some embodiments, counter 221 may be implemented with respect to each block of the video image. For example, counter 221 may include a plurality of counters corresponding to the plurality of blocks, respectively. Counter 221 may be stored, for example, by memory 220. In other embodiments, counter 221 may be implemented in any other suitable manner.

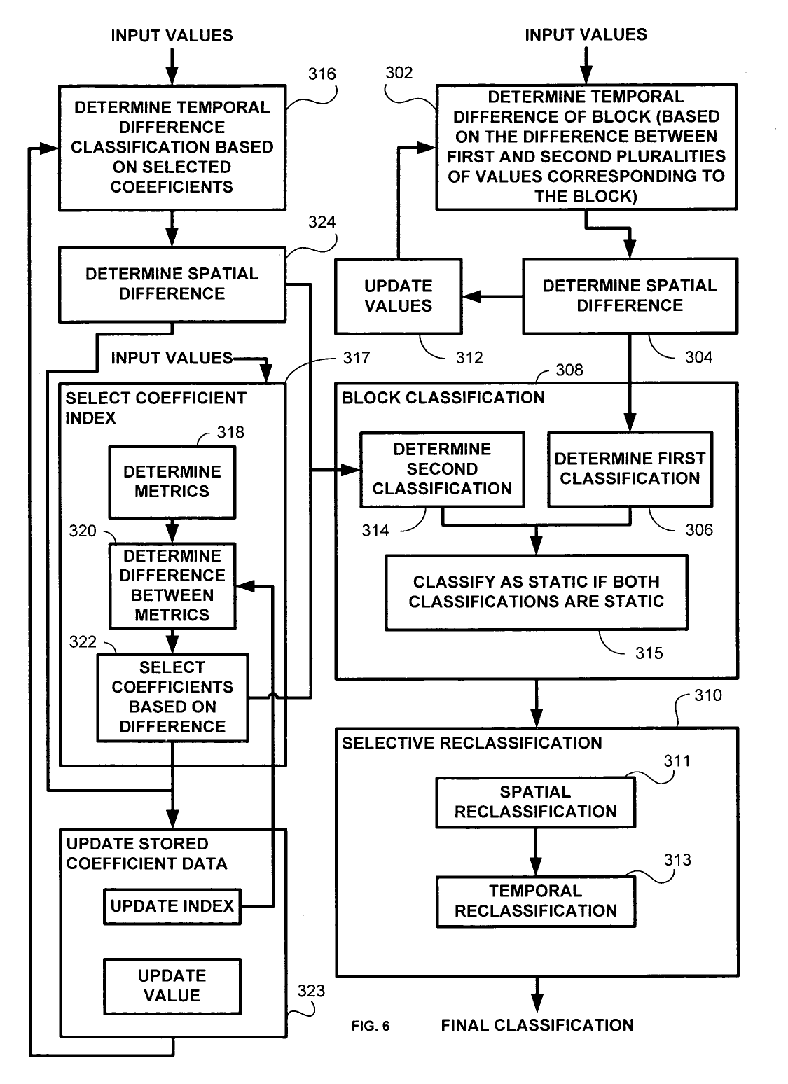

Reference is made to FIG. 6, which schematically illustrates a method of wireless video communication, in accordance with some demonstrative embodiments. In one embodiment, one or more operations of the method of FIG. 3 may be performed by transmitter 140 (FIG. 4), classifier 114 (FIG. 4) and/or classifier 200 (FIG. 5).

As indicated at block 302, the method may include determining at least one current temporal-difference value corresponding to a block of pixels based on a plurality of differences between a first plurality of values and a second plurality of values, respectively. The first plurality of values may includes values corresponding to current pixel values of the block in a current frame, and the second plurality of values may include values corresponding to previous pixel values of the block of pixels in one or more previous video frames.

In some embodiments, the first plurality of values include values of a plurality of transformation coefficients corresponding to the current pixel values, and the second plurality of values are based on previous values of the plurality of transformation coefficients corresponding to the previous pixel values, e.g., as described above.

In some embodiments, the plurality of transformation coefficients include at least a lowest-order spatial frequency coefficient of a plurality of DCT coefficients corresponding to the Y pixel component, a lowest-order spatial frequency coefficient of a plurality of DCT coefficients corresponding to the Cb pixel component, and a lowest-order spatial frequency coefficient of a plurality of DCT coefficients corresponding to a Cr pixel component. For example, classifier 202 (FIG. 5) may determine the temporal difference value err(n) based on coefficients 203 (FIG. 5), e.g., as described above.

As indicated at block 304, the method may include determining at least one current spatial-difference value corresponding to the block of pixels by applying a predefined averaging function to the current temporal-difference value corresponding to the block of pixels, and to at least one other current temporal-difference value corresponding to at least one other respective block of pixels. For example, classifier 202 (FIG. 5) may determine the spatial difference value err_filtₖ, e.g., as described above.

As indicated at block 312, the method may include updating the second plurality of values based on the first plurality of values. In some embodiments, updating the second plurality of values may include updating the second plurality of values based on the classification of the current pixel values of the block of pixels and/or the spatial difference value err_filtₖ. For example, classifier 202 (FIG. 5) may update the values stored in memory 220, e.g., as described above with reference to FIG. 5.

As indicated at block 316, the method may include determining a secondary current temporal-difference value corresponding to the block of pixels based on a difference between a value of a selected transformation coefficient of the plurality of transformation coefficients corresponding to the current pixel values of the block, and between a stored value, which is based on one or more transformation coefficient values corresponding to the previous pixel values of the block of pixels. For example, classifier 204 (FIG. 5) may determine the temporal difference value err′(n) based on coefficients 205 (FIG. 5), e.g., as described above.

A indicated at block 308, the method may include classifying the current pixel values of the block as either static or non-static based at least on the current spatial-difference value.

As indicated at block, 306, classifying the current pixel values of the block may include determining a first classification of the current pixel values of the block as either static or non-static based on the current spatial-difference value. For example, classifier 202 (FIG. 5) may determine classification 208 (FIG. 5) of the block based on the spatial difference value err_filtₖ, e.g., as described above.

As indicated at block 314, classifying the current pixel values of the block may include determining a second classification of the current pixel values of the block as either static or non-static based on the secondary current temporal-difference value. For example, classifier 204 (FIG. 5) may determine classification 210 (FIG. 5) of the block, e.g., as described above.

As indicated at block 324, in some embodiments the method may include determining a spatial difference value corresponding to the block based on the second temporal difference value, and determining the second classification based at least on the spatial difference value. For example, classifier 204 (FIG. 5) may determine classification 210 (FIG. 5) of the block based on the spatial difference value err_fit′ₖ, e.g., as described above.

As indicated at block 317 the method may include selecting a coefficient index corresponding to the current pixel values of the block, as described below.

As indicated at block 318, selecting the coefficient index may include determining a plurality of metrics corresponding, respectively, to the plurality of transformation coefficients, which correspond to the current pixel values of the block. For example, classifier 204 (FIG. 5) may determine the metrics metricⱼ, e.g., as described above.

As indicated at block 320, selecting the coefficient index may include determining a difference between first and second metrics of the plurality of metrics, wherein the first metric is the greatest of the plurality of metrics, and wherein the second metric corresponds to a transformation coefficient having an index equal to the stored index. For example, classifier 204 (FIG. 5) may determine the difference metricₘₐₓ−metricₘₑₘ, e.g., as described above.

As indicated at block 322, selecting the coefficient index may include determining the index of the selected transformation coefficient by selecting between a transformation coefficient corresponding to the greatest metric and the transformation coefficient having the stored index, e.g., based on the determined difference. For example, classifier 204 (FIG. 5) may select between the coefficients coeffₘₐₓ and coeffₘₑₘ based on the determined difference, e.g., as described above with reference to Conditions 10 and 11.

In some embodiments, determining the second classification, as indicated at block 314, may include determining the second classification as static only if the secondary current temporal-difference value is lesser than a predefined threshold, and the index of the selected transformation coefficient is equal to the stored index, e.g., as described above.

As indicated at block 323, the method may include updating the stored coefficient data. For example, updating the coefficient value coeffₘₑₘ, based on the currently selected coefficient value coeff(n), with reference to Equation 12. As indicated at block 323 updating the stored coefficient data may include updating the stored coefficient index to include the selected coefficient index.

As indicated at block 315, classifying the current pixel values of the block may include classifying the current pixel values of the block as static only if both the first and second classifications are static, e.g., as described above.

As indicated at block 310, the method may include selectively modifying the classification of the current pixel values of the block.

As indicated at block 311, selectively modifying the classification of the current pixel values of the block may include selectively modifying the classification based on the classification of one or more blocks of pixels adjacent to the block. For example, re-classifier 233 (FIG. 5) may selectively reclassify the classification 214 (FIG. 5) of the current pixel values of the block such that the current pixel values of the block are classified 217 (FIG. 5) as static only if the block is part of a sequence of a predefined number of blocks which are classified as static, e.g., as described above.

As indicated at block 313, selectively modifying the classification of the current pixel values of the block may optionally include selectively re-classifying the classification corresponding to a block based on the number of times the block has been previously classified as static. For example, temporal re-classifier 234 (FIG. 5) may determine the classification 218 (FIG. 5) of a block as static only if classification 217 (FIG. 5) of the block is static and the block has been previously classified as static for a predefined number of frames, e.g., as described above.

Some embodiments, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and/or an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed:

1. A method for transmitting video data comprising:
determining spatial/temporal deviation value of a given video block in a video frame relative to a corresponding video block in another frame; and
selecting a subset out of two or more possible subsets of transform coefficients of the given video block based on the determined deviation value.

2. The method according to claim 1, wherein selecting comprises comparing the deviation value of the given video block against a spatial/temporal deviation threshold value.

3. The method according to claim 2, wherein the threshold value is fixed.

4. The method according to claim 2, wherein the threshold value is dynamic based on a factor selected from the group consisting of data link quality, neighboring block deviation values and a deviation value calculated for a corresponding video block in a previous frame.

5. The method according to claim 2, wherein a video block with a deviation value exceeding the threshold value is characterized as dynamic.

6. The method according to claim 5, comprising selecting a subset of transform coefficients corresponding with relatively lower frequency components of the video block.

7. The method according to claim 6, further comprising transmitting the selected subset.

8. The method according to claim 2, wherein a video block with a deviation value not exceeding the threshold value is characterized as static.

9. The method according to claim 8, further comprising transmitting an indicator indicating static block status to a functionally associated receiver.

10. The method according to claim 8, wherein said receiver associates spatial data from a previous corresponding video block to the given static video block.

11. The method according to claim 10, further comprising selecting and transmitting a subset of transform coefficients for the given static video block from the previously unselected subsets of transform coefficients of the previous corresponding video block.

12. A video transmitting device comprising:
comparator adapted to determine a spatial/temporal deviation value of a given video block in a video frame relative to a corresponding video block in another frame; and
coefficient selector adapted to select a subset out of two or more possible subsets of transform coefficients of the given video block based on the determined deviation value.

13. The device according to claim 12, wherein selecting comprises comparing the deviation value of the given video block against a spatial/temporal deviation threshold value.

14. The device according to claim 13, wherein the threshold value is fixed.

15. The device according to claim 13, wherein the threshold value is dynamic and based on a factor selected from the group consisting of data link quality, neighboring block deviation values and a deviation value calculated for a corresponding video block in a previous frame.

16. The device according to claim 13, wherein a video block with a deviation value exceeding the threshold value is characterized as dynamic.

17. The device according to claim 13, wherein a video block with a deviation value not exceeding the threshold value is characterized as static.

18. The device according to claim 17, further comprising transmitting an indicator indicating static block status to a functionally associated receiver.

19. A video receiver adapted comprising:
A video block image generator adapted to associates spatial data from a previous corresponding video block to a current static video block upon receiving an a static block indicator for the current video block; and
Wherein said generator is further adapted to enhance the spatial data using complimenting coefficients.

20. A method of processing video data comprising:
selecting a set of transform coefficients to transmit for a given video block of a given video frame based on whether the video block is determined to be static or dynamic relative to a corresponding video block in a previous frame, wherein a set of transform coefficients selected for a video block determined to be static compliment a set of coefficients transmitted for the corresponding video block.

21. The method according to claim 20, further comprising transmitting the selected transform coefficients along with an indicator as to whether the transform coefficients are associated with a static or a dynamic video block.

22. The method according to claim 21, further comprising receiving a set of complimentary transform coefficients and using the complimentary coefficients to enhance a video block generated based on coefficients received for the corresponding video block.

23. The method according to claim 22, wherein enhancing includes completing an incomplete coefficient set.

24. The method according to claim 22, wherein enhancing includes averaging retransmitted corresponding coefficients.

25. The method according to claim 20, wherein determining whether a given video block is static or dynamic is at least partially based on a spatial/temporal deviation value for the given video block relative to the corresponding video block.

26. The method according to claim 25, wherein determining is also based on whether a neighboring video block is determined to be static or dynamic.
